(19) United States
(12) Patent Application Publication
(10) Pub. No.: US 2005/0105300 A1
(43) Pub. Date: May 19, 2005

(54) Lighting arrangement having a moisture-absorbing material

(76) Inventors: Istvan Pajer, Knittlingen (DE); Joachim Selinger, Muehlacker (DE); Hans Weiner, Muehlacker (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/778,318

(22) Filed: Feb. 17, 2004

(30) Foreign Application Priority Data
Feb. 15, 2003 (DE) 103 06 388.9

(51) Int. Cl. F21W 11/10

(52) U.S. Cl. 362/516

(57) ABSTRACT

A lighting arrangement has a lens and a shell which form the interior of a headlight. Reflectors and lights are provided in the interior of the headlight. Ventilating and deventilating ducts are provided on a rear side of the shell. A moisture-absorbing material is arranged in the interior of the headlight.

### BACKGROUND AND SUMMARY OF THE INVENTION

This application claims the priority of application no. 103 06 388.9 filed in Germany on Feb. 15, 2003, the disclosure of which is expressly incorporated by reference herein.

The invention relates to a lighting arrangement, particularly for motor vehicles, as known, for example, from German Patent Document DE 32 20 704 C2. Such a known headlight includes at least a glass pane, a shell and a reflector which jointly form the interior of the headlight. For ventilating and deventilating this interior, it is known from the state of the art to provide a ventilating duct at the lower shell edge and a deventilating duct at the upper shell edge, which are integrated in the headlight fastening and are constructed as a labyrinth seal.

The ventilating and deventilating of the interior of the lighting arrangement is required in order to prevent the precipitation of condensation water on the interior side of the lens and/or on the reflector. Such a condensate formation would, on the one hand, considerably impair the illuminating power of the headlight and, on the other hand, may lead to a corrosion of the reflector. Furthermore, a condensate formation in the interior of the headlight spoils the appearance of the headlight.

Simultaneously with the implementation of a ventilating and deventilating of the interior of the headlight, it is endeavored to ensure that no unnecessary moisture penetrates into the headlight through these ducts. This is very important, for example, in the case of cross-country vehicles which require a certain water wading depth.

The arrangement according to the invention has the advantage that, by placing a moisture-absorbing medium in the interior of the headlight, the moisture present in the interior of the headlight can be absorbed by this medium and a condensate formation will therefore be avoided to an even higher degree. There is also the advantage that the ventilating and deventilating ducts can have a minimal design or that they may even be eliminated completely so that a penetration of moisture into the headlight from the outside can be largely avoided. Advantageously, the moisture-absorbing material can be used in lighting arrangements which form a closed system as well as in the case of open systems.

Further advantageous improvements of certain preferred embodiments of the invention are provided by the measures indicated in the claims. Thus, according to certain preferred embodiments it is advantageous for the moisture-absorbing medium to be wrapped in a suitable material, such as a polyester nonwoven, and for the thus formed package to be fastened in the interior of the headlight at a location provided for this purpose. According to certain preferred embodiments of the invention, a monoblock produced from the moisture-absorbing material issued. Irrespective of the use of a monoblock or of a package with a moisture-absorbing material, this moisture-absorbing material can either be glued on at a location in the headlight or can be held, for example, by means of spring-type clips or screws at a location in the headlight. It is also advantageous according to certain preferred embodiments of the invention to provide a pocket-type projection already during the manufacturing of the headlight, behind which projection the package with the moisture-absorbing material can simply be deposited. Advantageously, this projection can be constructed in a grid shape so that an exchange of moisture absorbing material is easily possible.

Other objects, advantages and novel features of the present invention will become apparent from the following detailed description of the invention when considered in conjunction with the accompanying drawings.

### BRIEF DESCRIPTION OF THE DRAWINGS

The single drawing FIGURE is a basic sectional view of a headlight for motor vehicles with arrangement of moisture-absorbing medium in the headlight shell, constructed according to a preferred embodiment of the invention.

### DETAILED DESCRIPTION OF THE DRAWINGS

In the drawing FIGURE, the shell of the headlight has the reference number 10 and the lens has the reference number 11. These two components encompass the interior 12 of the headlight. In the case of modern headlights, conventionally several lights are provided in the interior of these lighting arrangements, which lights, together with their reflectors, are arranged such that high-beam lights, low-beam lights and optionally also fog and/or cornering lights are arranged in the headlight. In the drawing figure, symbolically, only one reflector is marked by reference number 13 and one light is marked by reference number 14. On the rear side of the headlight facing the vehicle, the ventilating and deventilating ducts are shown which have the reference number 15 in the figure.

A moisture-absorbing medium 16 is arranged in the interior 12 of the headlight. In the illustrated example, the moisture-absorbing material is wrapped in a polyester nonwoven, so that this package can be deposited on the rear side of the interior of the headlight in an indentation. This package can, for example, by means of an adhesive 17, be fixed to the rear side. Another possibility consists of providing a grid-type structure 18 which is held by clamps 19 so that, during the mounting, the package with the moisture-absorbing material 16 is deposited in the indentation of the headlight covered by the grid-type plate 18 and held by means of spring-type clamps. Another possibility consists of extending the grid-type plate 18 only over two thirds of the indentation, so that the package can simply be deposited in the forming cavity through the resulting opening.

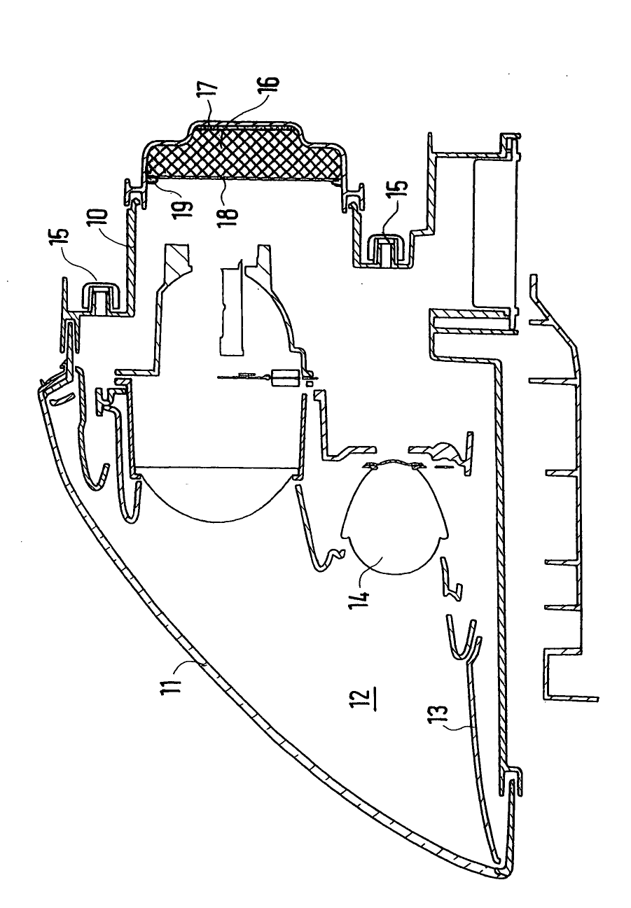

The location for depositing the package with the moisture-absorbing material indicated in FIG. 1 is only an example. It is also contemplated to deposit this moisture-absorbing material, for example, in the interior of the headlight on its bottom and to fix it there.

Irrespective of the arrangements, it only has to be ensured that the surface of the moisture-absorbing material is as freely accessible as possible for the moisture absorption in the interior of the headlight.

It was found during the development that particularly a crystal-type material with a specific surface of from 650 to 800 qm/g and a chemical composition of from 98 to 99% silicon oxide SiO₂ and 1% water H2O is suitable for use as a possible material.

In addition, the use of such a moisture-absorbing material is conceivable in the case of all lighting arrangements which have a closed interior and, because of their function, are subjected to different climatic conditions.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Lighting arrangement having a lens and a shell which form the interior of a headlight, reflectors and lights being provided in the interior of the headlight, wherein a moisture-absorbing medium is arranged in the interior of the headlight.

2. Lighting arrangement according to claim 1, wherein the moisture-absorbing medium has the form of granulates wrapped in a moisture-permeable material to form a package.

3. Lighting arrangement according to claim 1, wherein the moisture-absorbing medium is constructed in the form of a monoblock.

4. Lighting arrangement according to claim 1, wherein the moisture-absorbing medium is fixed in the interior of the headlight by means of gluing.

5. Lighting arrangement according to claim 1, wherein the moisture-absorbing medium is fixed in the interior by means of spring-type clamps or by means of screws.

6. Lighting arrangement according to claim 1, wherein the moisture-absorbing medium is deposited behind a grid-type plate.

7. Lighting arrangement according to claim 1, wherein a pocket-type projection is provided in the interior of the headlight, in which pocket-type projection a package with the moisture-absorbing medium is deposited during the manufacturing.

8. A vehicle headlight assembly comprising:
a shell and lens forming a substantially closed headlight interior space,
at least one light source provided in the interior space, and
a moisture absorbing medium arranged in the interior space and operable to absorb moisture therein.

9. An assembly according to claim 8, wherein the moisture-absorbing medium has the form of granulates wrapped in a moisture-permeable material to form a package.

10. An assembly according to claim 8, wherein the moisture-absorbing medium is constructed in the form of a monoblock.

11. An assembly according to claim 8, wherein the moisture-absorbing medium is fixed in the interior of the headlight by means of gluing.

12. An assembly according to claim 8, wherein the moisture-absorbing medium is fixed in the interior by means of spring-type clamps or by means of screws.

13. An assembly according to claim 8, wherein the moisture-absorbing medium is deposited behind a grid-type plate.

14. An assembly according to claim 8, wherein a pocket-type projection is provided in the interior of the headlight, in which pocket-type projection a package with the moisture-absorbing medium is deposited during the manufacturing.

15. An assembly according to claim 9, wherein a pocket-type projection is provided in the interior of the headlight, in which pocket-type projection the package with the moisture-absorbing medium is deposited during the manufacturing.

16. An assembly according to claim 8, wherein the moisture absorbing-medium has a specific surface ration of 650 to 800 m²/gram.

17. As assembly according to claim 8, wherein the moisture absorbing-medium has a chemical composites with 98%-99% Sᵢ O₂.

18. As assembly according to claim 16, wherein the moisture absorbing-medium has a chemical composites with 98%-99% Sᵢ O₂.
